(19) United States
(12) Patent Application Publication
(10) Pub. No.: US 2015/0185515 A1
(43) Pub. Date: Jul. 2, 2015

(54) LIQUID CRYSTAL DISPLAYING PANEL

(71) Applicant: CHUNGHWA PICTURE TUBES, LTD., Padeh City (TW)

(72) Inventors: TAI CHING YU, TAOYUAN CITY (TW); TSENG SHENG CHUN, BADE CITY (TW)

(73) Assignee: CHUNGHWA PICTURE TUBES, LTD., Padeh City (TW)

(21) Appl. No.: 14/243,239

(22) Filed: Apr. 2, 2014

(30) Foreign Application Priority Data
Dec. 30, 2013 (TW) 102224735

(51) Int. Cl. G02F 1/1339; G02F 1/1337

(52) U.S. Cl. CPC G02F 1/1339; G02F 1/1337

(57) ABSTRACT

An LCD panel includes a first substrate including a first alignment film; a second substrate including a second alignment film; and spacers disposed between the first substrate and the second substrate, wherein a section of each spacer is parallel to a surface of the first substrate, the section has a long axis and a short axis, the long axis is the longest straight line of the section, the short axis is perpendicular to the long axis, the length of the long axis is longer than the length of the short axis, and the section is formed by connecting two ends of the long axis to two ends of the short axis through smooth curved lines or straight lines, whereby when the first alignment film of the first substrate is aligned in a first alignment direction, the first alignment direction is the same as a direction of the long axis.

### CROSS-REFERENCE TO RELATED APPLICATION

This application claims the benefit of Taiwan Patent Application No. 102224735, filed on Dec. 30, 2013, which is hereby incorporated by reference for all purposes as if filly set forth herein.

### BACKGROUND

1. Technical Field

The present invention relates to a liquid crystal displaying (LCD) panel, and in particular to an LCD panel wherein when an alignment streak is formed, a separation point between the alignment streak and a spacer is generated backward.

2. Related Art

As the large dimension of an LCD panel is requested in the market, the uniformity of a gap between a color filter (CF) substrate and a thin film transistor (TFT) substrate is high requested gradually. Thus, the process for manufacturing spacers on the substrate (e.g., the CF substrate or the TFT substrate) is developed. The spacers can be formed at the predetermined positions by this manufacturing process, whereby the dispersal uniformity of the spacers can be further increased.

However, when the alignment film is aligned in an alignment direction by a roller, the alignment film which is located at the backward and low position of the spacers cannot be aligned, because alignment filaments of the roller are compressed due to the height of the spacer. As shown in FIGS. 1a to 1d, when the alignment film 910 is aligned in an alignment direction 950 by the roller 940, the alignment filaments 941 of the roller 940 may be simulated to flow lines. After the alignment film 910 is aligned by the alignment filaments 941 of the roller 940, a plurality of alignment streaks 911 are formed accordingly. A separation point 922 formed between the alignment streak 911 and the spacer 920 is located at a half of arc of a circular section of the spacer 920, such that the alignment film 910 which is located at the backward and low position of the spacer 920 has no alignment streak 911. Thus, liquid crystals cannot be provided with pre-tile angle and twist angle in the follow-up processes, so light leakages 930, 930′ of pixels 960, 960′ may be generated. When the LCD panel is in a light test process, the longitudinally alignment mura (i.e., the light leakages 930, 930′) can be found at the position adjacent to the spacer 920 located between pixels 960, 960′. Therefore, it is required to provide an LCD panel capable of solving the forgoing problems.

### SUMMARY

The present invention is directed to an LCD panel wherein the problem of the longitudinally alignment mura can be decreased.

To achieve the objective, the present invention provides an LCD panel includes a first substrate including a first alignment film; a second substrate including a second alignment film; and a plurality of spacers disposed between the first substrate and the second substrate, wherein a section of each spacer is parallel to a surface of the first substrate, the section has a long axis and a short axis, the long axis is the longest straight line of the section, the short axis is perpendicular to the long axis, the length of the long axis is longer than the length of the short axis, and the section is formed by connecting two ends of the long axis to two ends of the short axis through smooth curved lines or straight lines, whereby when the first alignment film of the first substrate is aligned in a first alignment direction, the first alignment direction is the same as a direction of the long axis.

The LCD panel of the present invention can be applied to the technical field of In Plane Switching (IPS) and Fringe Field Switching (FFS). The sections of the spacers can be in the shapes of ellipse, diamond or water-drop cone. When the first alignment film is aligned in the first alignment direction by the roller, the alignment filaments of the roller may be simulated to flow lines. After the first alignment film is aligned by the roller, a plurality of alignment streaks are formed accordingly. During the formation of alignment streaks, a separation point between the alignment streak and the spacer is generated backward, whereby the first alignment film which is located at the backward and low position of the spacer can be aligned. Further, liquid crystals can be provided with pre-tile angle and twist angle, so light leakages of pixels can be decreased. When the LCD panel is in a light test process, the problem of the longitudinally alignment mura can be decreased.

### BRIEF DESCRIPTION OF THE DRAWINGS

FIG. 1a is a top view of a spacer and an alignment film in the prior art;

FIG. 1b is a cross-sectional view of a spacer and an alignment film in the prior art;

FIG. 1c is a schematic view showing that the longitudinally alignment mura is found in a light test process of a conventional LCD panel;

FIG. 1d is a schematic view showing that the longitudinally alignment mura is found in a light test process of another conventional LCD panel;

FIG. 2 is a flow chart of a method for manufacturing an LCD panel according to an embodiment of the present invention;

FIG. 3a to FIG. 3f are cross-sectional views showing a method for manufacturing an LCD panel according to an embodiment of the present invention;

FIG. 4 is a top view of a spacer and an alignment film of the present invention, wherein the section of the spacer is in the shape of water-drop cone;

FIG. 5 is a top view of a spacer and an alignment film of the present invention, wherein the section of the spacer is in the shape of ellipse;

FIG. 6 is a top view of a spacer and an alignment film of the present invention, wherein the section of the spacer is in the shape of diamond; and

FIG. 7 is a schematic view showing that an LCD panel of the present invention is in a light test process.

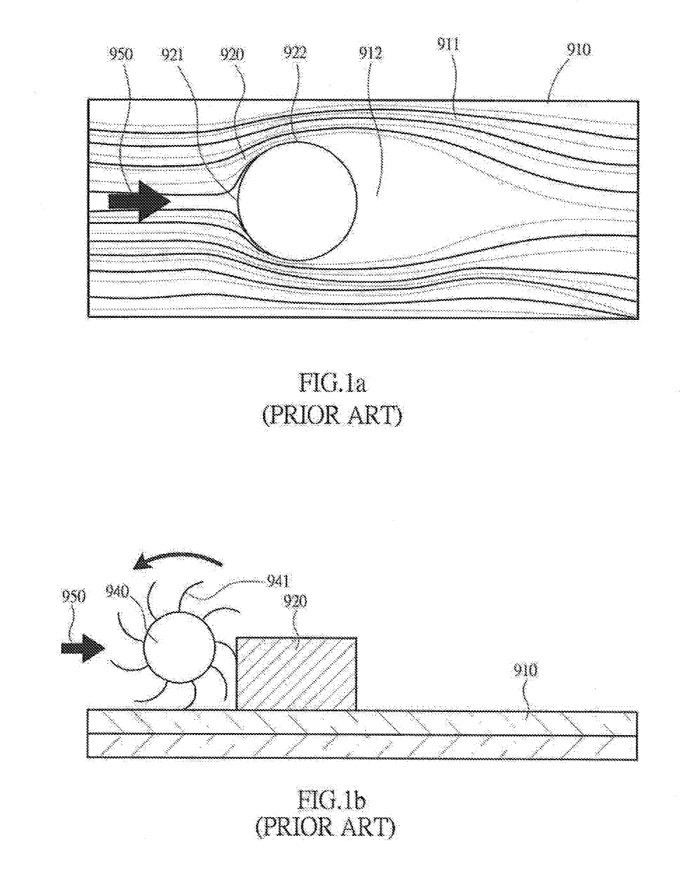

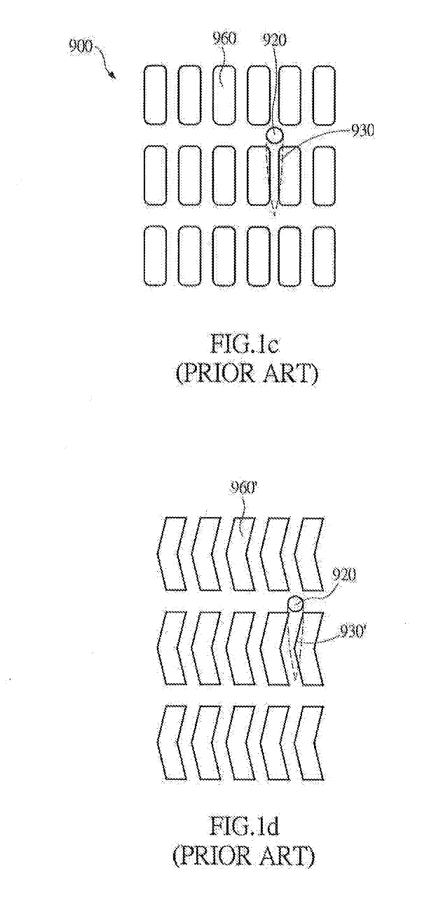

### DETAILED DESCRIPTION

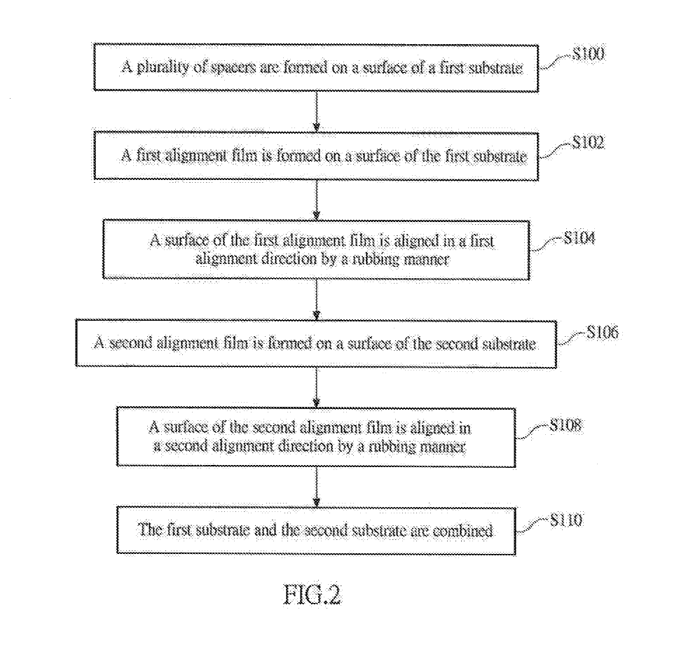

FIG. 2 is a flow chart of a method for manufacturing an LCD panel according to an embodiment of the present invention. The method includes steps as follows:

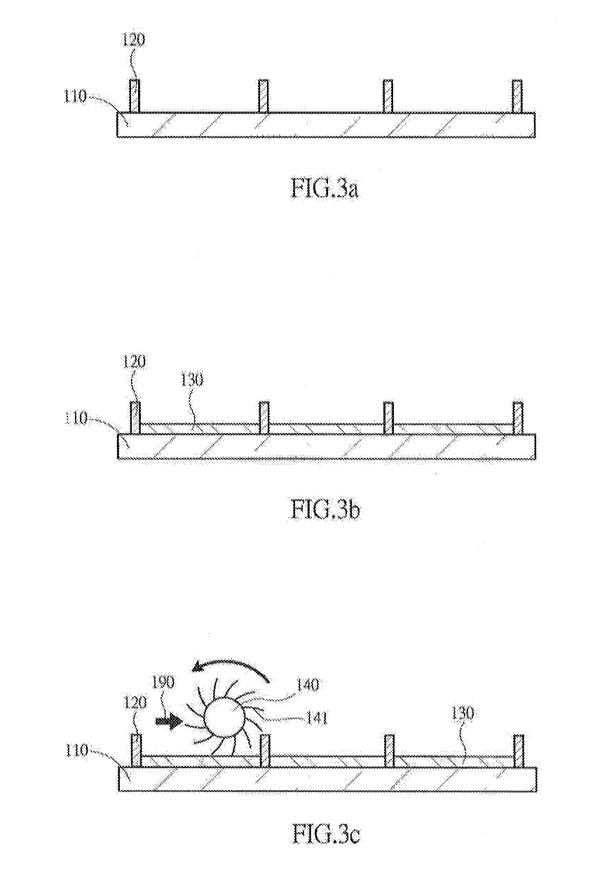

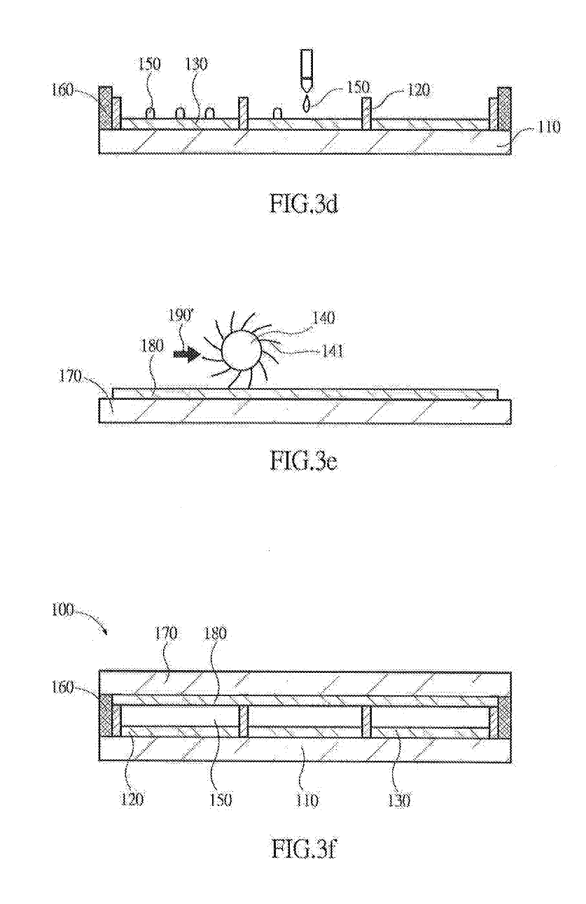

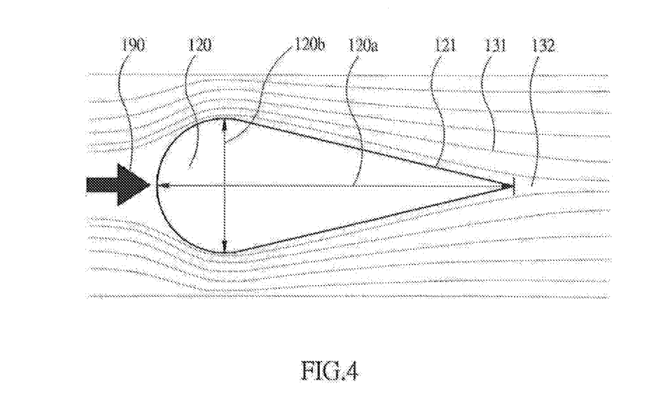

Step S100: a plurality of spacers are formed on a surface of a first substrate. Referring to FIG. 3a, in this step, a photoresist pattern is formed on a surface of a first substrate 110, and then forms a plurality of spacers 120. The first substrate 110 can be a CF substrate. The method for manufacturing the CF substrate: a light shading layer (i.e., black matrix) is formed on a glass substrate, filter layers having three primary colors red, green and blue) are formed sequentially, a flat protective layer is coated over the filter layers, and finally a transparent conductive film (e.g., Indium Tin Oxide, ITO) is sputtered on the flat protective layer.

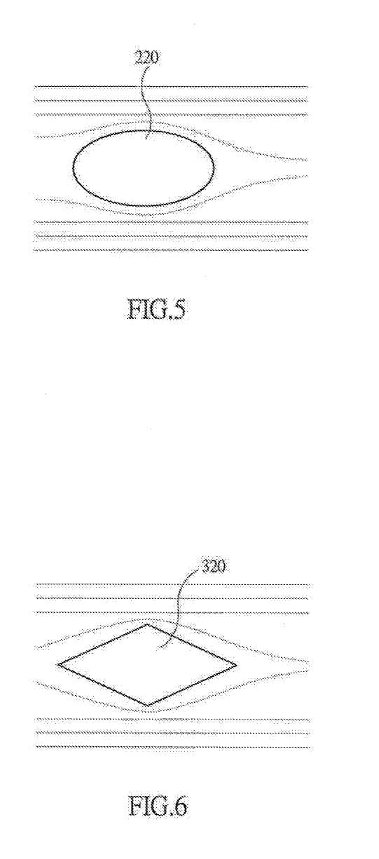

FIG. 4 is a top view of a spacer according to the present invention. A section of each spacer 120 is parallel to a surface of the first substrate 110, and the section has a long axis 120a and a short axis 120b. The long axis 120a is the longest straight line of the section. The short axis 120b is perpendicular to the long axis 120a, the length of the long axis 120a is longer than the length of the short axis 120b, and the section is formed by connecting two ends of the long axis 120a to two ends of the short axis 120b through smooth curved lines or straight lines. The sections of the spacers 120 can be in the shapes of ellipse, diamond or water-drop cone. FIG. 4 shows that the section of the spacer 120 is in the shape of water-drop cone, FIG. 5 shows that the section of the spacer 120 is in the shape of ellipse, and FIG. 6 shows that the section of the spacer 120 is in the shape of diamond. In this embodiment, the sections of the spacers 120 which are in the shape of water-drop cone are an example described below.

Step S102: a first alignment film is formed on a surface of the first substrate. Referring to FIG. 3b, in this step, the surface of the first substrate 110 is cleaned, so as to ensure that a surface of the transparent conductive film (e.g., ITO) of the first substrate 110 is clear. Then, the first alignment film 130 is coated on the surface of the first substrate.

Step S104: a surface of the first alignment film is aligned in a first alignment direction by a rubbing manner. Referring to FIGS. 3c and 4, in this step, the surface of the first alignment film 130 is aligned in the first alignment direction 190 by the rubbing manner, a plurality of alignment streaks 131 are formed accordingly. The alignment direction of the alignment streaks 131 is the same as a direction of the long axis 120a of the spacers 120. A purpose of the alignment is to control the arrangement directions of liquid crystal molecules for providing necessary pre-tilt angles of different LCD panels. The rubbing manner during the alignment is that: the first substrate is put on a moving platform, a plurality of alignment streaks 131 are formed on the surface of the first alignment film 130 by using alignment filaments 141 of the roller 140 to rub the first alignment film 130 in the first alignment direction 190, whereby the alignment is completed, wherein the material of the alignment filaments 141 can be made of nylon filaments or artificial filaments.

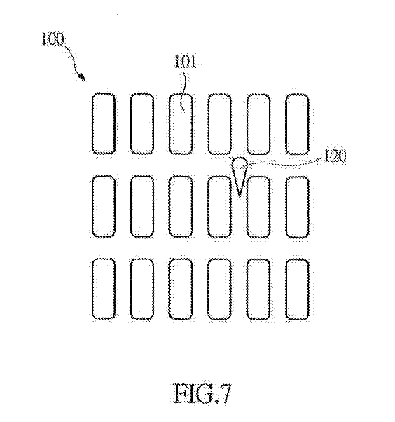

When the first alignment film 130 is aligned in the first alignment direction 190 by the roller 140, the alignment streaks 131 are formed accordingly. Since the sections of the spacers 120 are in the shapes of ellipse, diamond or water-drop cone, a separation point 121 between the alignment streak 131 and the spacer 120 is generated backward, whereby the first alignment film 130 can have the alignment streaks 131 which is located at the backward and low position 132 of the spacer 120 in the first alignment direction 190. In other words, the alignment streaks 131 are formed along a surface of the spacer 120, the separation point 121 formed between the alignment streak 131 and the spacer 120 is located at the backward position of the alignment streak 131 in the first alignment direction 190. Further, liquid crystals can be provided with pre-tile angle and twist angle in the follow-up processes, so light leakages of pixels can be decreased. When the LCD panel is in a light test process, the problem of the longitudinally alignment mura at the backward and low position of the spacer 120 located between pixels can be decreased, shown in FIG. 7.

Referring to FIG. 3d, after the alignment streaks 131 are finished, liquid crystal molecules 150 can be disposed on the first alignment film 130 and between two adjacent spacers 120 by a one drop fill process. Then, a sealant 160 is coated around an edge of the first substrate 110.

Step S106: a second alignment film is formed on a surface of the second substrate. Referring to FIG. 3e, in this step, the surface of the second substrate 170 is cleaned, so as to ensure that the surface of the second substrate 170 is clear. Then, the second alignment film 180 is coated on the surface of the second substrate 170. The second substrate 170 can be a TFT substrate.

Step S108: a surface of the second alignment film is aligned in a second alignment direction by a rubbing manner. Referring to FIG. 3e, in this step, the surface of the second alignment film 180 is aligned by the rubbing manner, a plurality of alignment streaks are formed accordingly. The rubbing manner during the alignment is that: the second substrate 170 is put on a moving platform, a plurality of alignment streaks are formed on the surface of the second alignment film 180 by using alignment filaments 141 of the roller 140 to rub the second alignment, film 180 in the second alignment direction 190′, whereby the alignment is completed. In other words, the second alignment film 180 of the second substrate 170 has the alignment streaks formed in the second alignment direction 190′. The second alignment direction 190′ is perpendicular to the first alignment direction 190. In another embodiment, the second alignment direction 190′ may be not perpendicular to the first alignment direction 190 according to the product design, but the angle between the second alignment direction 190′ and the first alignment direction 190 is larger than 90 degrees.

Step S110: the first substrate and the second substrate are combined. Referring to FIG. 3f, in this step, the first substrate 110 and the second substrate 170 are combined, and the sealant 160 is solidified.

As described above, the LCD panel is finished by the above-mentioned step S100 to step S110. Referring to FIGS. 3f and 4, the LCD panel 100 includes a first substrate 110, a second substrate 170 and a plurality of spacers 120. The first substrate 110 includes a first alignment film 130. The first alignment film 130 includes a plurality of alignment streaks 131 formed thereon. The second substrate 170 includes a second alignment film 180. The spacers 120 are disposed between the first substrate 110 and the second substrate 170, wherein a section of each spacer 120 is parallel to a surface of the first substrate 110, the section has a long axis 120a and a short axis 120b, the long axis 120a is the longest straight line of the section, the short axis 120b is perpendicular to the long axis 120a, and the long axis 120a is longer than the short axis 120b. When the first alignment film 130 of the first substrate 110 is aligned in a first alignment direction 190, the first alignment direction 190 is the same as the direction of the long axis 120a of the section of each spacer 120.

In another embodiment, when the first substrate 110 can be a TFT substrate, the second substrate 170 can be a CF substrate.

In conclusion, the LCD panel of the present invention can be applied to the technical field of In Plane Switching (IPS) and Fringe Field Switching (FFS). The sections of the spacers can be in the shapes of ellipse, diamond or water-drop cone. When the first alignment film is aligned in the first alignment direction by the roller, the alignment filaments of the roller may be simulated to flow lines. After the first alignment film is aligned by the roller, a plurality of alignment streaks are formed accordingly, During the formation of alignment streaks, a separation point between the alignment streak and the spacer is generated backward, whereby the first alignment film which is located at the backward and low position of the spacer can be aligned. Further, liquid crystals can be provided with pre-tile angle and twist angle, so light leakages of pixels can be decreased. When the LCD panel is in a light test process, the problem of the longitudinally alignment mura at the backward and low position of the spacer located between pixels can be decreased.

Described in the foregoing are merely implementation manners or embodiments for presenting the technical means employed in the present invention for solving the problems, and these implementation manners or embodiments are not intended to limit the implementation scope of the present invention patent. Any equivalent change and modification made in consistency with the content of the scope of the present invention patent application or in accordance with the scope of the present invention patent shall fall within the scope of the present invention patent.

What is claimed is:

1. An liquid crystal displaying (LCD) panel, comprising:
a first substrate including a first alignment film;
a second substrate including a second alignment film; and
a plurality of spacers disposed between the first substrate and the second substrate, wherein a section of each spacer is parallel to a surface of the first substrate, the section has a long axis and a short axis, the long axis is the longest straight line of the section, the short axis is perpendicular to the long axis, the length of the long axis is longer than the length of the short axis, and the section is formed by connecting two ends of the long axis to two ends of the short axis through smooth curved lines or straight lines, whereby when the first alignment film of the first substrate is aligned in a first alignment direction, the first alignment direction is the same as a direction of the long axis.

2. The LCD panel according to claim 1, wherein the first substrate is a thin film transistor (TFT) substrate, and the second substrate is a color filter (CF) substrate.

3. The LCD panel according to claim 1, wherein the first substrate is a CF substrate, and the second substrate is a TFT substrate.

4. The LCD panel according to claim 1, wherein the sections of the spacers are in the shape of ellipse.

5. The LCD panel according to claim 1, wherein the sections of the spacers are in the shape of diamond.

6. The LCD panel according to claim 1, wherein the sections of the spacers are in the shape of water-drop cone.

7. The LCD panel according to claim 1, wherein the first alignment film has a plurality of alignment streaks which is located at the backward and low position of the spacer in the first alignment direction.

8. The LCD panel according to claim 7, wherein the second alignment film of the second substrate has the alignment streaks formed in the second alignment direction.

9. The LCD panel according to claim 8, wherein the first alignment direction is perpendicular to the second alignment direction.

10. The LCD panel according to claim 8, wherein the angle between the first alignment direction and the second alignment direction is larger than 90 degrees.

11. The LCD panel according to claim 7, wherein the alignment streaks are formed along a surface of the spacer, and a separation point formed between the alignment streak and the spacer is located at the backward position of the alignment streak in the first alignment direction.
